(19) United States
(12) Patent Application Publication
(10) Pub. No.: US 2013/0064049 A1
(43) Pub. Date: Mar. 14, 2013

(54) WATCH WITH SHAPEABLE STRAP

(71) Applicants: Anna Maria PILERI, Olbia (OT) (IT); Elisabetta CARMINATI, Arzachena (OT) (IT)

(72) Inventors: Anna Maria PILERI, Olbia (OT) (IT); Elisabetta CARMINATI, Arzachena (OT) (IT)

(73) Assignee: OCEAN REEF, INC., San Marcos, CA (US)

(21) Appl. No.: 13/612,366

(22) Filed: Sep. 12, 2012

(30) Foreign Application Priority Data
Sep. 13, 2011 (IT) MI2011U 000296

(51) Int. Cl. G04B 37/00; G04B 37/22

(52) U.S. Cl. 368/280; 368/282

(57) ABSTRACT

There is described a watch (10) comprising a case (12) enclosing a mechanism or clockwork (14), a clockwork holding support (18) and a strap. The strap consists of at least one flexible sheet (24) made of a metal material, having such a length as to be wound by bending and shaped around the wrist or a generic part of a user's body for steadily keeping the watch (10) in position. The flexible sheet (24) is inserted within a sheath (26) made of a non metal material intended for contacting the part of the user's body. Therefore, no clasp is required for the strap of the watch (10) since the flexible sheet (24) and the relative sheath (26) remain steadily rolled up around the part of the user's body, irrespective of the size of such part of the body (wrist, ankle, forearm, etc.), when the same watch (10) is worn.

The present invention relates to a watch provided with a strap that can be shaped on the wrist or another part of a user's body, such as for example the ankle or the forearm.

The strap is one of the most important accessories of a wristwatch, undoubtedly contributing to define the style and embellish the overall appearance thereof. Several varieties of strap for wristwatches are known: in fact, next to the typical leather hide straps one can find plastic, steel, fabric straps and many other materials, generally available in different colours and sizes.

Several clasp systems are also known for the strap of a wristwatch, among which we may mention, by way of an example, the clasp of the buckle type with tongue, the so-called “deployante” clasp, consisting of bending sheets that are overlapped and locked in closed position thanks to a snap clip, the Velcro® clasp, used in particular on children's watches, and others.

However, the most common clasp systems of the known type exhibit some drawbacks. The clasp of the buckle type, generally used on straps made of non metal materials, is usually difficult to actuate both in the closing step and in the opening step of the strap. In addition, this type of clasp may damage the strap up to breaking it, subsequent to a very prolonged use.

The so-called “deployante” clasp, generally used on straps made of metal material, is particularly sturdy but requires an accurate assembly of several components. Moreover, with this type of clasp it is necessary to adjust the strap length beforehand, i.e. before wearing the watch, to adjust it to the user's wrist size.

The general object of the present invention therefore is to provide a watch provided with shapeable strap capable of solving the drawbacks of the prior art mentioned above in a very simple, inexpensive and particularly functional manner.

In detail, it is an object of the present invention to provide a watch provided with shapeable strap which is easy to wear on the user's wrist and as easy to remove.

Another object of the invention is to provide a watch provided with shapeable strap that needs no adjustment to fit to the size of the user's wrist.

A further object of the invention is to provide a watch provided with a shapeable strap that may be worn not just on the wrist but also on other parts of the user's body, such as for example the ankle or the forearm.

Yet another object of the invention is to provide a watch provided with shapeable strap which is safe, sturdy and good looking.

These objects according to the present invention are achieved by providing a watch provided with shapeable strap as outlined in claim 1.

Further features of the invention are described in the dependent claims, which are an integral part of the present specification.

The features and advantages of a watch provided with shapeable strap according to the present invention will appear more clearly from the following description, made by way of an non-limiting example with reference to the annexed schematic drawings, wherein:

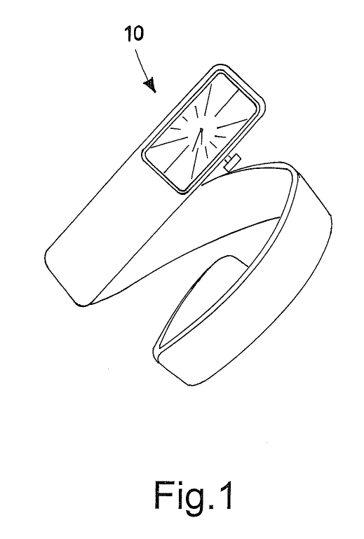

FIG. 1 shows a perspective view of a preferred embodiment of a watch provided with shapeable strap according to the present invention;

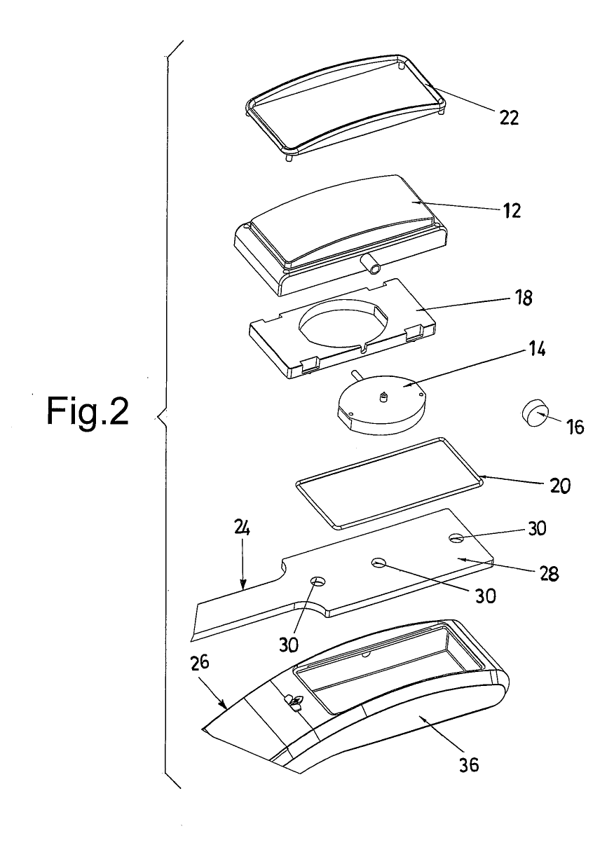

FIG. 2 shows an exploded view of the main components of the watch provided with shapeable strap shown in FIG. 1;

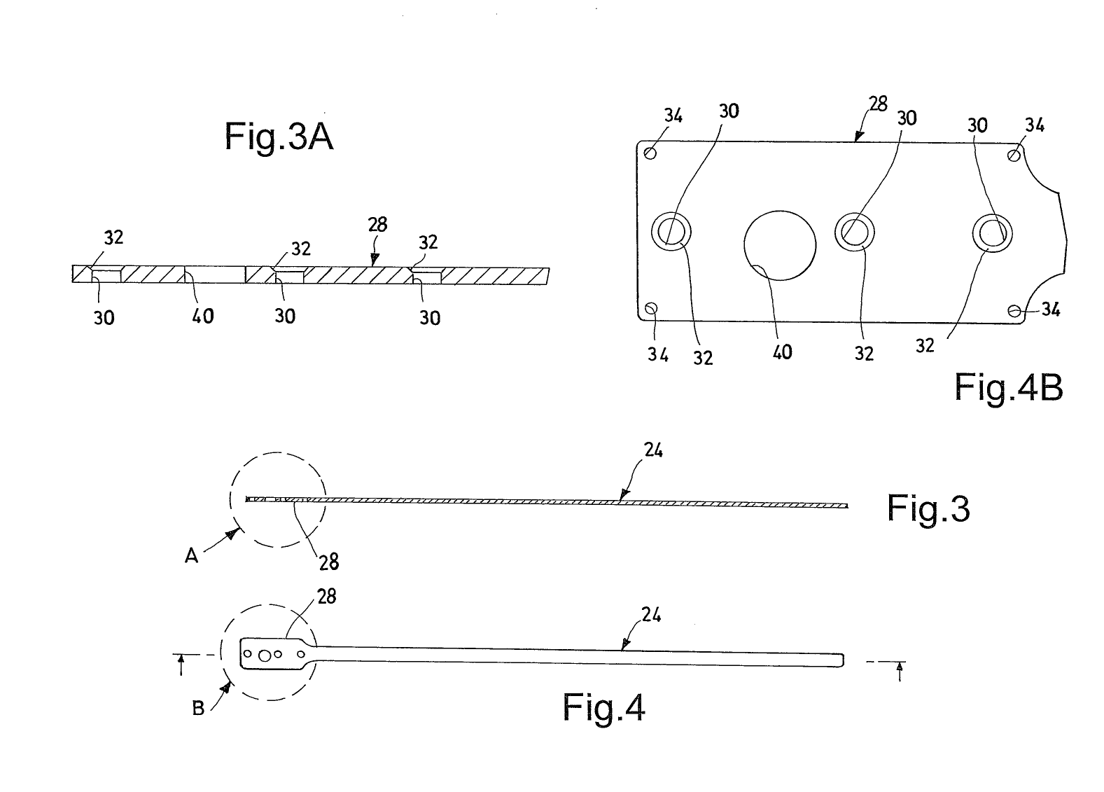

FIG. 3 shows a longitudinal section view of a first component of the watch strap shown in FIG. 1;

FIG. 3A shows an enlarged view of the detail indicated with letter A in FIG. 3;

FIG. 4 shows a plan view of the component of the watch strap shown in FIG. 3;

FIG. 4B shows an enlarged view of the detail indicated with letter B in FIG. 4;

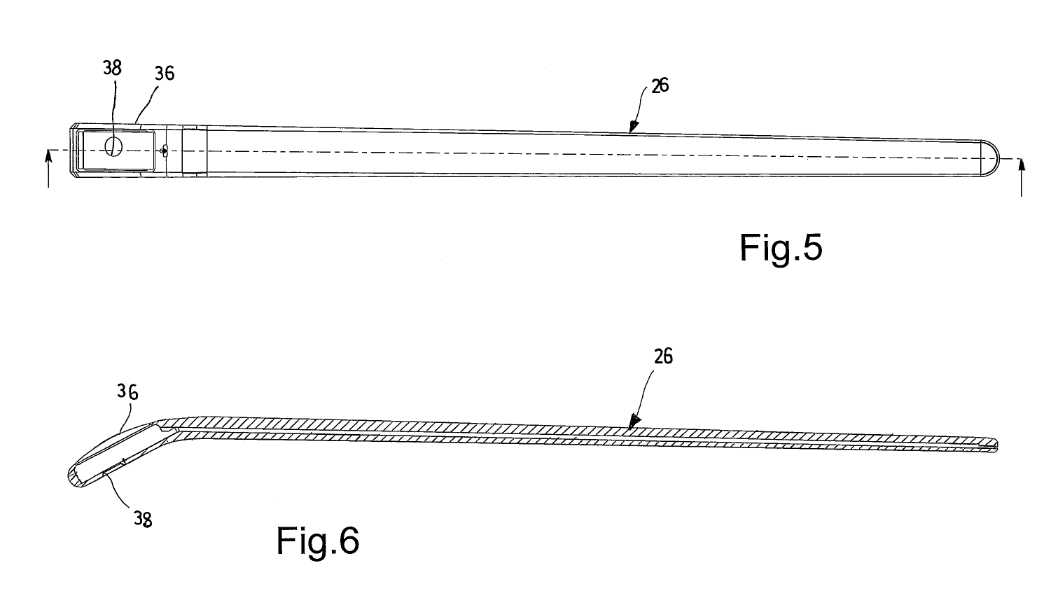

FIG. 5 shows a plan view of another component of the watch strap shown in FIG. 1; and

FIG. 6 shows a longitudinal section view of the component of the watch strap shown in FIG. 5.

With reference to the figures, there is shown a watch provided with shapeable strap according to the present invention, globally indicated with reference numeral 10. Watch 10 comprises, in a per se known manner and based on the preferred embodiment shown in the figures, a case 12 that encloses a mechanism or clockwork 14 provided with an adjustment crown 16, a clockwork holding support 18 and a sealing gasket 20. A frame 22 may also be provided, which surrounds the glass of case 12 for ornamental purpose. The mechanism or clockwork 14 may be of any type known in the art, such as for example mechanical or quartz, and the dial of case 12 may be of any type as well, such as analogue or digital.

Watch 10 further comprises a strap which, according to the invention, consists of at least one flexible sheet 24 made of a metal material, preferably aluminium, having such a length as to be wound by bending and shaped around a part of a user's body, typically the wrist, for steadily keeping the same watch 10 in position. The flexible sheet 24 is inserted within a sheath 26 made of a non metal material, preferably elastomeric, intended for contacting the user's wrist.

Therefore, no clasp is required for the strap of watch 10 since the flexible sheet 24 and the relative sheath 26 remain steadily rolled up around the user's wrist, irrespective of the size of such wrist, when the same watch 10 is worn. Only by applying a predetermined force it is possible to return such flexible sheet 24 and the relative sheath 26 to a substantially flat and rectilinear configuration, so as to release the user's wrist. The value of the above force, calculated based on the thickness, dimensions and material the flexible sheet 24 is made of, is in any case such as to prevent an accidental detachment of the watch 10 from the user's wrist.

The length of the flexible sheet 24 and of the relative sheath 26 may be such as to allow watch 10 to be worn not only on the wrist but also on other parts of the user's body. By way of an example, watch 10 may be worn on the forearm, the ankle, as hair clip or in any other way, according to the user's taste.

The flexible sheet 24 is irremovably constrained, at one of its ends, to the case 12 of the watch 10. Based on the embodiment shown in the figures, such end of the flexible sheet 24 is provided with a plate 28 whereon a first series of through holes 30 is obtained, wherein corresponding pins (not shown) made integral with the base of the case 12, are inserted.

The through holes 30 are provided at the top with truncated-cone recessed portions 32, which facilitate the insertion of the pins of case 12 into the same through holes 30 during the strap assembly step. Preferably, the pins of case 12 are made of a plastic material and may be constrained to plate 28 by a thermal bonding process. Plate 28 may also be provided with a second series of external through holes 34 which allow access to the screws that fix the mechanism or clockwork 14 of the watch 10 to the case 12, so as to allow extraordinary maintenance operations on such mechanism or clockwork 14.

Sheath 26 is provided with a head portion 36 capable of wrapping at least partly the case 12 of the watch 10, so that there is no metal part or joint in contact with the user's wrist. However, at least one opening 38 may be provided on the base of such head portion 36, placed at a corresponding opening 40 provided on the plate 28 of the flexible sheet 24, so as to access the case 12 for allowing the normal maintenance operations on the mechanism or clockwork 14 of the watch 10, such as for example replacing the battery if the same watch 10 is of the quartz type.

Although in the embodiment described so far and shown in the figures reference is made to a single flexible sheet 24 inserted within the relative sheath 26, the strap of the watch 10 according to the invention may also be provided with two separate flexible sheets 24, which extend on opposite sides of case 12 of watch 10. In that case, the two flexible sheets 24, which may have the same or different length, are inserted into respective sheaths 26 of corresponding length, separate from each other or made integral and provided or not with the head portion 34 capable of wrapping at least partly the case 12 of the watch 10.

Thanks to the elastomeric material it is preferably made of, and irrespective of the embodiment that envisions one or two flexible sheets 24, logos, patterns and precious or not precious stones may be easily applied or carved onto sheath 26, so as to provide the watch 10 with a distinctive character. It is understood that sheath 26 may be made of any material suitable for coating the respective flexible sheet 24, such as for example natural or synthetic leather, hide, fabric and others. If made of precious materials and/or embellished with precious or semiprecious stones, the watch 10 may also be used as a jewel.

It has thus been seen that the watch provided with shapeable strap according to the present invention achieves the objects described above.

In any case, several changes and variations may be made to the watch provided with shapeable strap thus conceived, all falling within the same inventive concept; moreover, all the details may be replaced with technically equivalent elements. In the practice, the materials used as well as shapes and sizes, may be whatever, according to the technical requirements.

The scope of protection of the invention is therefore defined by the annexed claims.

1. Watch (10) comprising a case (12) which encloses a mechanism or clockwork (14), a clockwork holding support (18) and a strap, characterised in that the strap consists of at least one flexible sheet (24) made of a metal material, having such a length as to be wound by bending and shaped around the wrist or a generic part of a user's body for steadily keeping the watch (10) in position, said flexible sheet (24) being inserted within a sheath (26) made of a non metal material, intended for contacting the part of the user's body, said flexible sheet (24) and the relative sheath (26) remaining steadily rolled up around the part of the user's body when the watch (10) is worn.

2. Watch (10) according to claim 1, characterised in that the flexible sheet (24) is irremovably constrained, at one of its ends, to the case (12) of the watch (10).

3. Watch (10) according to claim 2, characterised in that said end of the flexible sheet (24) is provided with a plate (28) whereon a first series of through holes (30) is obtained, wherein corresponding pins are inserted, made integral with the base of the case (12).

4. Watch (10) according to claim 3, characterised in that said through holes (30) are provided at the top with truncated-cone recessed portions (32), which facilitate the insertion of the pins of the case (12) in said through holes (30) during the strap assembly step.

5. Watch (10) according to claim 3, characterised in that the pins of the case (12) are made of a plastic material and can be constrained to the plate (28) by a thermal bonding process.

6. Watch (10) according to claim 3, characterised in that the plate (10) is provided with a second series of external through holes (34) which allow access to the screws that fix the mechanism or clockwork (14) of the watch (10) to the case (12), so as to allow extraordinary maintenance operations on said mechanism or clockwork (14).

7. Watch (10) according to claim 3, characterised in that the sheath (10) is provided with a head portion (36) capable of wrapping at least partly the case (12) of the watch (10), so that there is no metal part or joint in contact with the part of the user's body.

8. Watch (10) according to claim 7, characterised in that at least one opening (38) is provided on the base of said head portion (36), placed at a corresponding opening (40) provided on the plate (28) of the flexible sheet (24), so as to access the case (12) for allowing the normal maintenance operations on the mechanism or clockwork (14) of the watch (10).

9. Watch (10) according to claim 1, characterised in that it comprises two separate flexible sheets (24), which extend on opposite sides of the case (12) of the watch (10), said two flexible sheets (24) being inserted into respective sheaths (26) of corresponding length.

10. Watch (10) according to claim 1, characterised in that the flexible sheet (24) is made of aluminium and the sheath (26) is made of an elastomeric material.
